(19) United States
(12) Patent Application Publication
(10) Pub. No.: US 2010/0110826 A1
(43) Pub. Date: May 6, 2010

(54) Fractal static mixer

(76) Inventor: Eric J. D'herde, Grand Blanc, MI (US)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/291,091

(22) Filed: Nov. 6, 2008

(51) Int. Cl. B01F 5/08; B01F 13/00

(52) U.S. Cl. 366/337; 366/341

(57) ABSTRACT

A multiple-stage static mixer utilizing fractally progressive stages wherein the flow of materials is divided and rotated through an angle about the flow axis at each stage. Each stage is mathematically derived in a power progression from the previous stage to have an increased number of mixing modules, for example, 1, 4, 16, 64, or 1, 3, 9, 27, in accordance with the series L/n⁰, L/n¹, L/n² . . . L/n^{j} wherein L is the transverse length of a stage and n is the number of elements in each mixing module and sub-module. Mixing thus proceeds from relatively coarse to very fine in just a few stages which is a far more efficient methodology than is found in prior art non-progressive multiple-stage static mixers. The mixer may be adapted to both round and rectangular flow tubes and is especially suited to mixing multiple streams of gases.

### TECHNICAL FIELD

The present invention relates to mixers for homogenizing inhomogeneous fluid mixtures; more particularly, to static mixers having no moving parts; and most particularly, to a static mixer having sequential fractal stages derived in a power progression.

### BACKGROUND OF THE INVENTION

Static mixers for homogenizing inhomogeneous fluid mixtures are well known. See, for example, U.S. Pat. Nos. 7,331,705; 7,316,503; and 7,338,543. A static mixer is defined herein as a mixing device with no moving parts, as opposed to a dynamic mixer. Static mixers can be very useful in applications wherein dynamic mixing is either unnecessary or impractical, as in the inline mixing of a plurality of flowing fluid materials, whether gaseous or liquid.

A problem not recognized in the prior art is a need to mix in sequential stages at progressively finer levels. In general, prior art static mixers comprise a plurality of substantially identical mixing units that purport to achieve homogeneity by providing a very large number of fluid crossings or turbulences within the overall flow stream. However, if the material flow stream is highly inhomogeneous and/or striated across the cross-sectional area of the flow tube, it can be very difficult achieve homogeneity in a mixer having multiple but identical stages. Effective mixing may require a large number of stages, occupying a relatively large volume, being expensive to manufacture, and causing a large and undesirable pressure drop through the mixer.

What is needed in the art is a simple, short, and relatively inexpensive static mixing device.

It is a principal object of the present invention to provide homogeneity from disparate conjoined streams, and especially gaseous materials, which streams may differ in, for example, composition, density, temperature, and/or flow rate.

It is a further object of the invention to provide such homogeneity within a static mixer having relatively few stages.

### SUMMARY OF THE INVENTION

Briefly described, a multiple-stage static mixer in accordance with the present invention utilizes a modular pattern and fractally progressive sub-modular patterns wherein the flow of materials is divided and rotated through a central angle about the flow axis of each modular and sub-modular pattern at each stage. The modular pattern comprises a plurality of elements spaced apart rotationally, each element being inclined to the flow axis. Each stage is mathematically related to the previous stage to have a power progression in an increased number of modular patterns. For example, a four-element mixer has four elements in the first stage, 16 elements in the second stage, and 64 elements in the third stage. Similarly, a three-element mixer has three elements in the first stage, 9 elements in the second stage, and 27 elements in the third stage. Mixing thus proceeds from relatively coarse to very fine in just a few elements which is a far more efficient methodology than is found in prior art non-progressive multiple-stage static mixers. The mixer may be adapted to both round and rectangular flow tubes and is especially suited to mixing multiple streams of gases.

### BRIEF DESCRIPTION OF THE DRAWINGS

The present invention will now be described, by way of example, with reference to the accompanying drawings, in which:

FIG. 1 is an isometric view of a mixing module in accordance with the present invention;

FIG. 2 is a elevational front view of the mixing module shown in FIG. 1, showing clockwise rotation of flow through the module;

FIG. 3 is a symbolic representation of the mixing module shown in FIGS. 1 and 2;

FIG. 4 is a symbolic representation of a second-stage, fractal mixing module;

FIG. 5 is a symbolic representation of a third-stage fractal mixing module;

FIG. 6 is a schematic isometric view of a rectilinear three-stage fractal mixer in accordance with the present invention;

FIG. 7 is a schematic isometric view of a cylindrical three-stage fractal mixer in accordance with the present invention; and

FIG. 8 is an elevational front view of a tubular fractal mixer.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

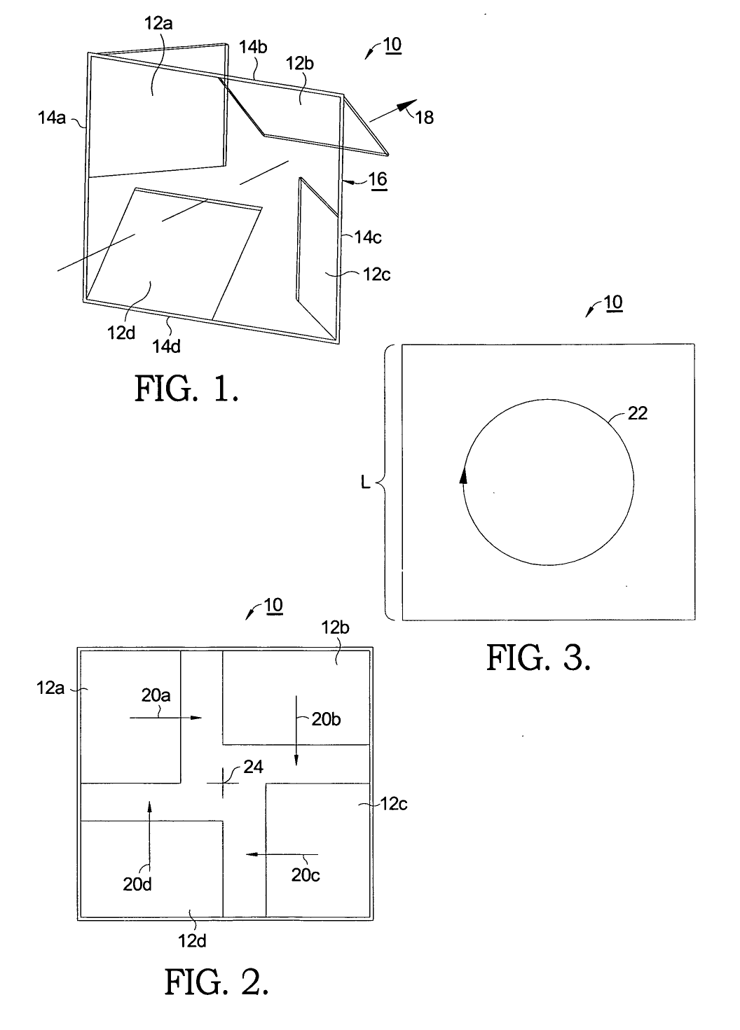

Referring to FIGS. 1 through 3, a module 10 is shown, defining a first stage for a multi-stage fractal mixer in accordance with the present invention. The mixer employs a series of spaced-apart stages disposed sequentially in a flow path for homogenization of an inhomogeneous fluid mixture, as described below. The sequential stages use the same mixer pattern at various scales, based on iterative affine transformations in a mathematical power progression. For the following discussion, an exemplary mixer having a square cross-section is employed, although a mixer in accordance with the present invention is not limited to any specific cross-sectional shape, including for example round (tubular) or hexagonal.

Module 10 employs four mixing elements 12a, 12b, 12c, 12d, each element being secured along a first edge 14a, 14b, 14c, 14d in a plane 16 generally transverse of the direction 18 of fluid flow through module 10. It will be seen that module 10 may be formed conveniently from a single square of sheet stock by cutting along the bisectors of the opposite sides and then from each corner to the midpoint of each side. The resulting n number of elements 12a, 12b, 12c, 12d may then be turned at a predetermined angle from plane 16 in axial direction 18. Fluid flowing in axial direction 18 of the mixer upon striking each element will be diverted in respective directions 20a, 20b, 20c, 20d, imparting, in the example, an overall clockwise spin 22 about axis 24 to the flowing material as it passes through first stage module 10, shown symbolically in FIG. 3. (Of course, it will be appreciated that an enantiomorphic module, not shown, will impart a counterclockwise spin, to equal effect).

Module 10 may be considered to have a length L along each side that preferably is also the transverse dimension of the fluid conduit into which module 10 is to be installed. To provide fluid rotation and mixing at progressively reduced scales, in accordance with the present invention, homothetical modules of fractional lengths of L are produced and installed as follows.

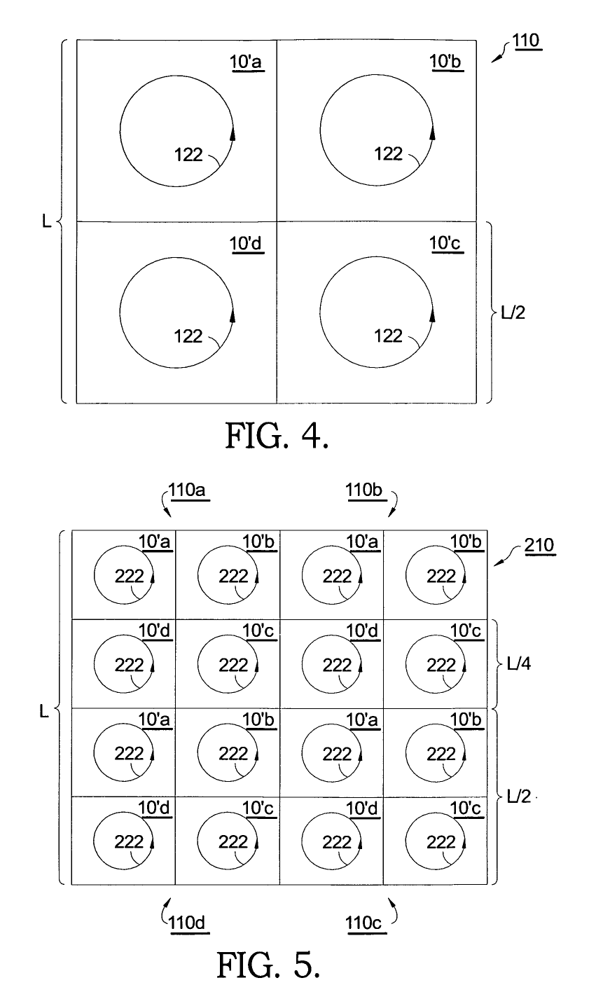

Referring now to FIG. 4, a second stage module 110 having an overall side length L comprises n¹ sub-modules each having n mixing elements, in the present example n being 4 (10′a, 10′b, 10′c, 10′d), each sub-module having a side length L/2. In a flow conduit, module 110 is axially spaced apart from module 10 by a distance preferably of approximately L. The total fluid flow striking module 110 is thus divided into four equal flows, each of which is turned, in the example, in a clockwise direction 122 in passing through module 110.

Similarly, and referring now to FIG. 5, a third stage module 210 having an overall side length L comprises n sub-modules, 110a, 110b, 110c, 110d, in turn comprising n² sub-modules 10, each having a side length of L/4. Again, module 210 is axially spaced apart from module 110 by a distance preferably of approximately L. The total fluid flow striking module 210 is thus divided into n²=16 equal flows, each of which is turned in a clockwise direction 222 in passing through module 210.

The multiple stages of a mixer in accordance with the present invention thus are related by the general power series L/n⁰, L/n¹, L/n² . . . L/n^{j}, where n is the number of mixing modules and may be any integer. It will be appreciated that this series may be extended to any desired value of j, although in practice for mixing gases a three-stage series wherein n=4 has been found to provide a high degree of homogeneity. It will be further appreciated that for values of n>4, the number of sub-modular units 10 rapidly becomes unwieldy, e.g., n=5 (5, 25, 125), or n=6 (6, 36, 216). Thus, mixers wherein n=3 or 4 are generally preferable.

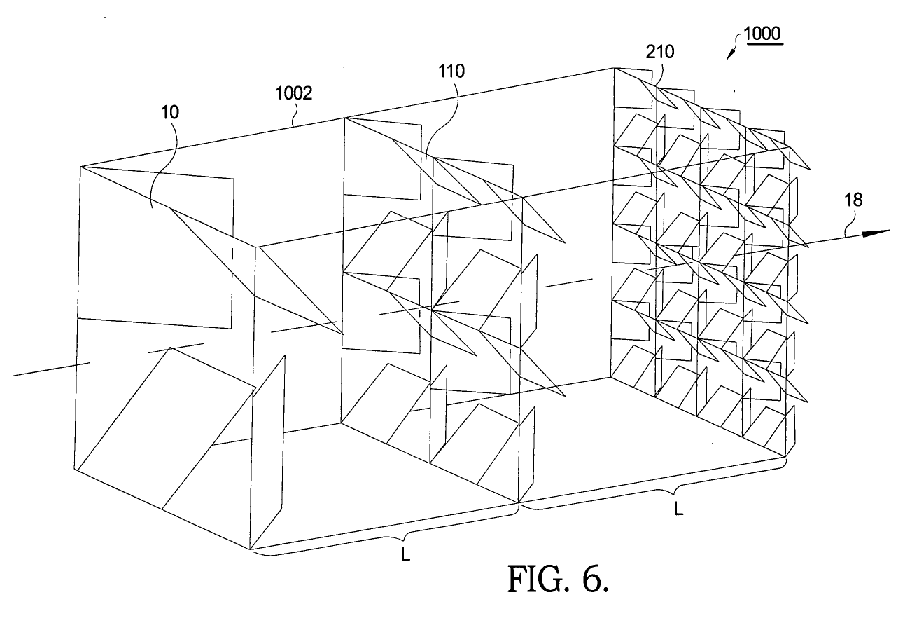

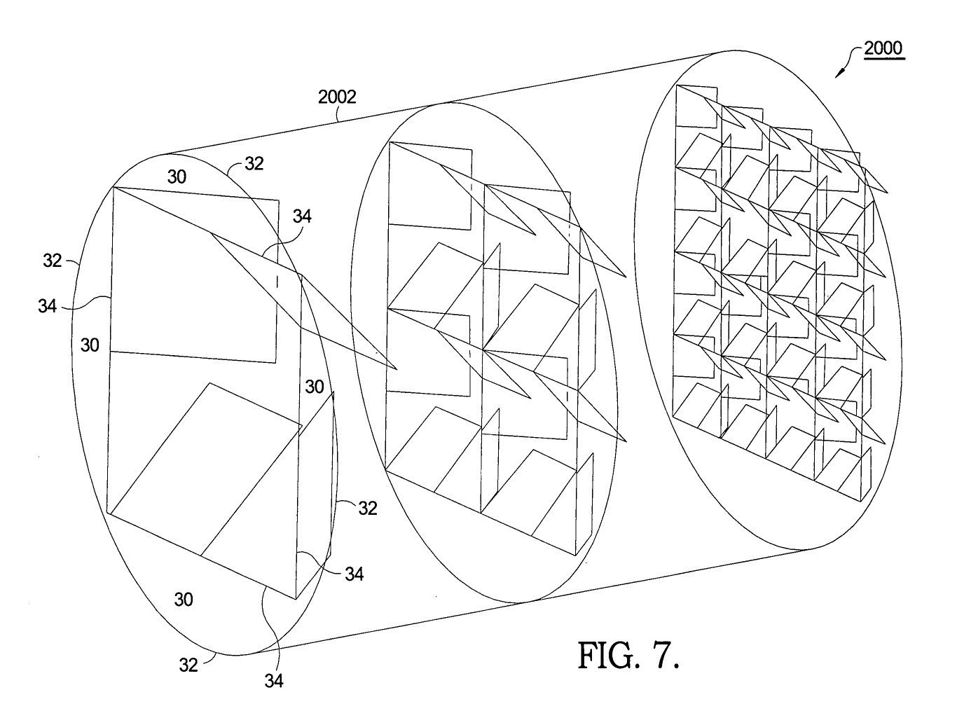

Referring to FIG. 6, a three-stage mixer 1000 comprising rectangular stages 10, 110, 210 as just described is shown for installation in a rectangular flow conduit 1002.

As noted above, a mixer in accordance with the present invention may be adapted to a flow conduit of any desired cross-sectional shape, for example, and referring now to FIG. 7, a cylindrical tube 2002 comprising three-stage mixer 2000. In this example, each stage may be formed, as by stamping, from a circular blank of sheet stock. Each module thus includes four portions 30 formed between the arc 32 and the chord 34 (identical with L) of each side of the rectangular mixer element. Portions 30 prevent channeling of fluid past the stages.

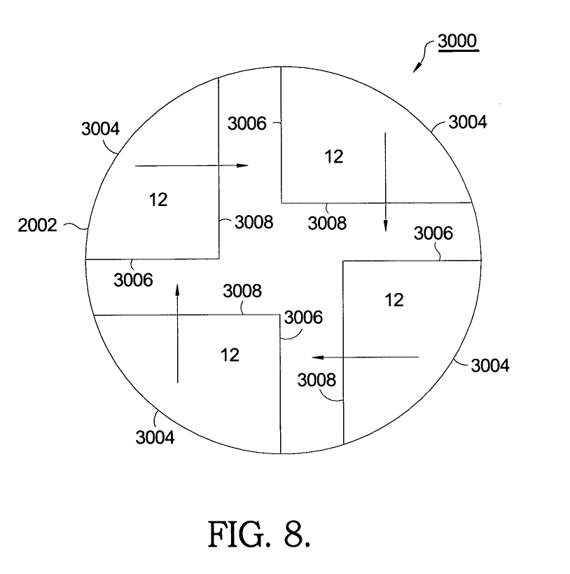

Referring to FIG. 8, a front elevational view is shown of another embodiment 3000 of a multiple-stage mixer in accordance with the present invention. Although n=4, it is seen that each individual element 12 is formed having a curved side 3004, substantially elliptical, to fit the inner wall of cylindrical tube 2002. Free edges 3006, 3008 may be formed as desired, although preferably entrance edges 3006 lie in plane 16 (FIG. 1) transverse to the direction of flow. In the example shown, the free corners are square, but obviously any other desired angle and shape to elements 12 may be provided within the scope of the present invention. It will be seen that manufacture of a mixer 3000 is likely to be considerably more complicated and expensive than the previously-described examples, as the mixing elements of each stage must be formed and attached individually to the inner wall of cylindrical tube 2002, rather than simply stamping each stage from sheet stock as described above for mixers 1000, 2000.

In summary, a multi-stage fluid mixer in accordance with the present invention comprises an assemblage of modular and sub-modular stages of modular length L/n⁰ and sub-modular lengths L/n¹, L/n² . . . L/n^{j} located at various distances downstream from the initial module of unit length L/n⁰. The smallest scale and the distances between stages may be optimized for any particular application, based on process parameters such as mass flow rate, temperature, pressure, and the like. Individual flow rotations may be either clockwise or counterclockwise, and rotation orientations may be combined in any stage in any desired combination.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A static mixing device comprising a plurality of sequential mixing stages for homogenizing a flowing fluid in a conduit, where the configuration of each of said sequential mixing stages is derived from the immediately preceding stage in a power progression.

2. A device, in accordance with claim 1, wherein each of said sequential mixing stages is derived mathematically.

3. A static mixing device in accordance with claim 1 comprising:
a) a first stage having a length L transverse to said direction of flow of said flowing fluid, and having a plurality n of angularly spaced-apart mixing elements, each of said mixing elements approaching a wall of said conduit and being inclined to said wall at an angle to said direction of flow; and
b) a plurality of spaced-apart sequential stages, each stage having a transverse length L and comprising a plurality of mixing sub-modules fractally derived from the immediately previous stage in a power series wherein L/n⁰ defines said first stage, L/n¹ defines a second stage, L/n² defines a third stage, and L/n^{j} defines a jth stage.

4. A static mixing device in accordance with claim 3 wherein n=4.

5. A static mixing device in accordance with claim 3 wherein j=2.

6. A static mixing device in accordance with claim 1 wherein the cross-sectional shape of said conduit is selected from the group consisting of square, rectangular, circular, and hexagonal.

7. A static mixing device in accordance with claim 3 wherein said plurality of angularly spaced-apart mixing elements are oriented such that said flowing fluid in passing through said first stage is rotated in a direction selected from the group consisting of clockwise and counterclockwise.

8. A static mixing device in accordance with claim 7 wherein mixing elements in any of said sequential stages are oriented such that said flowing fluid in passing through any sub-module of any sequential stage is rotated in a direction selected from the group consisting of clockwise and counterclockwise.
